(19) United States
(12) Patent Application Publication
(10) Pub. No.: US 2003/0110702 A1
(43) Pub. Date: Jun. 19, 2003

(54) Glazing with a mechanical member bonded thereto

(76) Inventors: Luigi Capriotti, S.Benedetto del Tronto (IT); Ciro Paudice, Vasto (IT)

Correspondence Address: BURNS DOANE SWECKER & MATHIS L L P, POST OFFICE BOX 1404, ALEXANDRIA, VA, 22313-1404, US

(21) Appl. No.: 10/181,889

(22) PCT Filed: Jan. 25, 2001
(86) PCT No.: PCT/IT01/00037

(30) Foreign Application Priority Data
Jan. 25, 2000 (EP) 00830042.8

(51) Int. Cl. B60J 1/16

(52) U.S. Cl. 49/375

(57) ABSTRACT

A mechanical member for bonding to a glazing comprises a universal first or base part and a second part which is specific to a particular class of glazing. The glazing may be for a vehicle window, in which case the second part may be adapted to a particular vehicle model. The first part is bonded to the glazing by adhesive, and the second part is maintained in position by engagement with the first part. The mechanical member may be a bracket for a vertically sliding door glazing, or a centring pin, fixing stud, retaining clip, positioning lug or locating spacer. A corresponding method employing a solid tack-free heat-resistant adhesive is also disclosed.

The present invention relates to a glazing with a mechanical member bonded to it. The mechanical member may take a wide variety of forms; for instance it may be a means, such as a bracket, for attaching the glazing to a larger mechanism or assembly, such as a window-opening mechanism; or it may be a means such as a pin, clip, spacer or lug which assists during installation of the glazing in an aperture. The mechanical member may serve to attach an item of equipment to the glazing. The glazing may, but need not, be for a vehicle window such as a rear window, door window or other side window, windscreen or rooflight.

It is known practice for glazing manufacturers to bond such mechanical members to the glazing with adhesive, usually as one of the final steps in the manufacture of the glazing, and shortly before the glazing is despatched to the customer, who is typically a vehicle manufacturer. Not surprisingly, each customer has a preferred design of bracket, pin, clip, spacer, lug or other mechanical member, and frequently such components are also specific to particular models of vehicle assembled by the customer.

In modern glazing factories it is standard practice for the operation of bonding a mechanical member to a glazing to be carried out by one or more robots, or with the assistance of other dedicated machinery. Consequently, in order to change a production line over from the production of a particular glazing to a differing glazing (e.g. one for a different model of vehicle, or for a different customer), it is generally necessary to change the tooling on the robot or other machinery, and quite possibly change the control programme as well. The tooling to be changed may for example include storage magazines for the mechanical members and grippers for handling the members. Other items such as transport stillages and packing, spacers may also need to be changed to accommodate glazings with a different mechanical member attached. Clearly, the more equipment that must be changed, the longer the changeover will take, and the consequent downtime will contribute to higher costs.

Many of these mechanical members protrude significantly from the glazing. This causes difficulty in handling, with the possibility of damage, either to the member or to surrounding objects, in particular, other glazings. It also causes difficulties in packing, reducing the packing density (i.e. the number of glazings that can be packed in a particular space, e.g. per stillage) and requiring bulky spacing material, again adding to costs.

It would be desirable to alleviate the above problems associated with mechanical members as they are presently used. It has now been realised that this can be achieved by providing the mechanical member in two parts, a base part of universal applicability, and a second part which is specific to the requirements of the customer or glazing concerned.

According to the present invention there is provided a glazing with a mechanical member attached thereto, characterised in that:

the mechanical member comprises a first or base part bonded to the glazing by adhesive, and a second part maintained in position by engagement with the first part, wherein the first part is a standardised design usable with several differing designs of second part, each adapted to a differing glazing.

The standardised base can be bonded in the appropriate position(s) to all glazings which require one or more mechanical members to be attached, and the appropriate second part engaged with it (either before or after bonding of the base). The second part may be a bracket, fixing, centring or other locating pin, clip, spacer or lug, and is adapted for a particular customer or vehicle model.

Use of a standardised base obviates the need to change tooling (which is specific to the design of base) on robots or other machinery, with consequent time and cost savings on changeovers. Furthermore, the second part of the mechanical member need not be attached until after transport of the glazings to the customer's premises. As the standardised base may be of a generally thin, flat design, the problem of the mechanical member protruding from the glazing and causing damage, or being damaged is also obviated.

Preferably, the first part of the mechanical member is in the form of a thin disc, and the second part has a hole of generally corresponding size and shape so that one part may receive the other part. This reduces the first part to the simplest possible design of broadest applicability, while facilitating packing of the glazings as described above.

Alternatively, especially in the case of a mechanical member being a bracket for a vertically sliding door glazing, the first part may extend over the edge of the glazing, and the second part is attached to the first part in such a way that the second part does not extend over any part of the glazing.

The invention also provides a method of making a glazing with a mechanical member attached thereto, characterised by the steps of:

(a) providing a pane of giazing material, and a mechanical member comprising a first or base part of a standardised design and a second part which is one of several differing designs of second part adapted to differing glazings, the first part being usable with the differing designs of second part,

(b) applying adhesive to the pane or the first part of the mechanical member,

(c) positioning the first part on the pane, and maintaining it in position until the adhesive has partially cured, and

(d) engaging the second part of the mechanical member with the first part so as to maintain the second part in position, wherein step (d) may be performed before or after step (c).

The invention will now be further described by way of the following specific embodiments, which are given by way of illustration and not of limitation, with reference to the accompanying drawings in which:

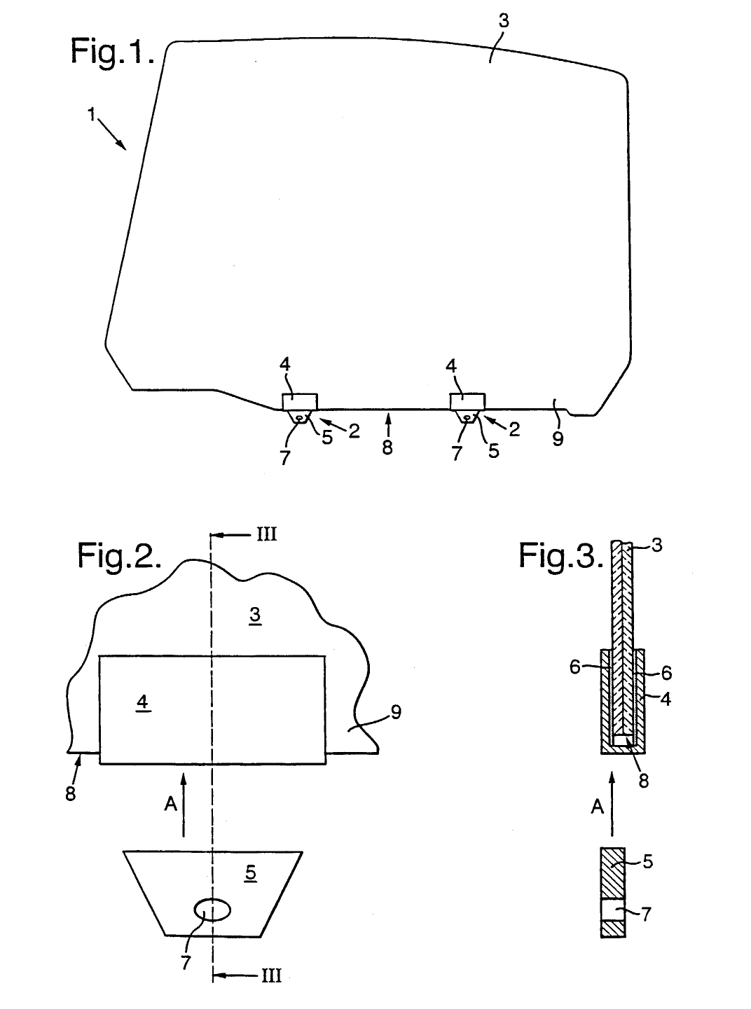

FIG. 1 shows a glazing with two mechanical members attached;

FIG. 2 is an enlargement of a small part of the glazing of FIG. 1, showing one of the mechanical members in a disassembled condition;

FIG. 3 is a cross-sectional view corresponding to FIG. 2, and taken on the line III-III in FIG. 2;

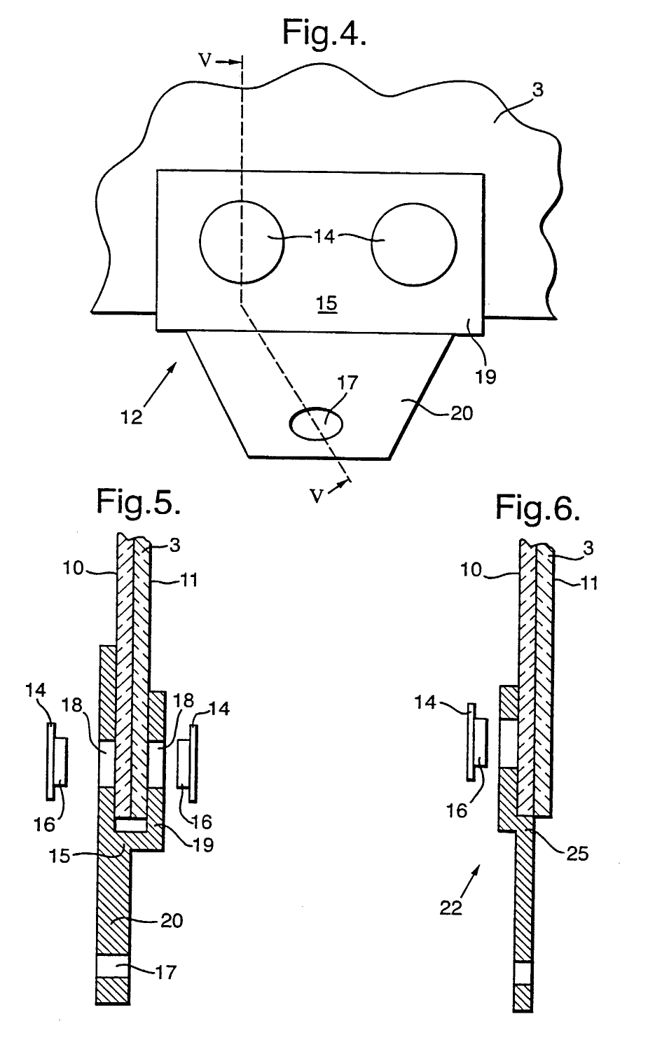

FIG. 4 shows a small part of a glazing with a second embodiment of mechanical member bonded to it;

FIG. 5 is a cross-sectional view corresponding to FIG. 4, and taken on the line V-V in FIG. 5;

FIG. 6 is a cross-sectional view of a third embodiment of mechanical member;

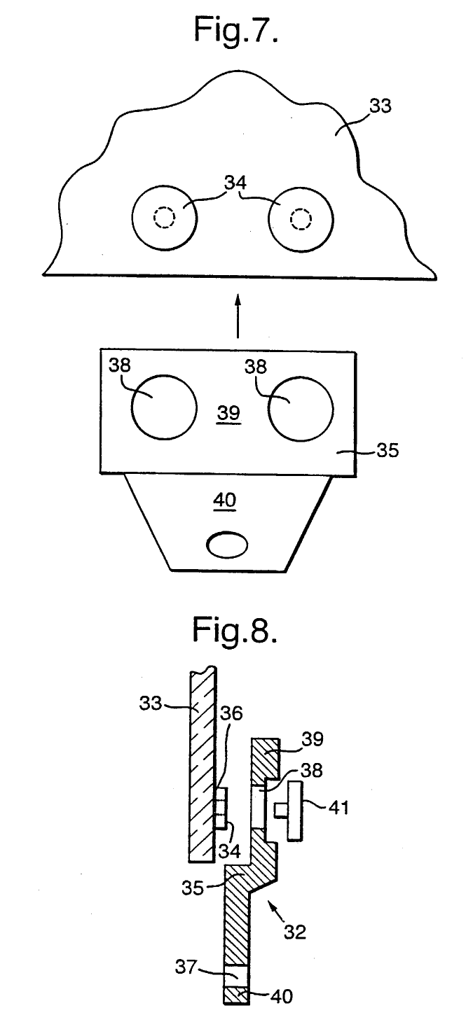

FIG. 7 shows a small part of a glazing together with a fourth embodiment of mechanical member in a disassembled condition;

FIG. 8 is a cross-sectional view of the fourth embodiment of mechanical member, with the relative positions of the parts changed in comparison with FIG. 7.

With reference to FIG. 1, there is shown a glazing 1 which is a door glazing for an automotive vehicle, e.g. a passenger car. The door glazing slides vertically in a door frame (not shown), and as is well-known, its vertical position and movement are controlled by a. window winding mechanism (not shown), which in the past was operated manually, but is nowadays often driven by an electric motor. The door glazing is attached to the winding mechanism by means of mechanical members in the form of door glazing brackets 2.

The glazing 1 comprises a pane 3 of sheet glazing material, which may be safety glass, i.e. toughened glass or laminated glass, or a plastics material such as polycarbonate, or indeed a composite of both glass and plastics glazing materials.

FIGS. 2 and 3 show the bracket in more detail and in disassembled condition. It comprises a first or base part 4, which is bonded to the glazing by adhesive 6, and a second part 5. The base part 4 is of a standardised design which may be used on all door glazings produced by a particular glass manufacturer. For instance, the base part shown is of generally rectangular shape in side view, with a U-shaped cross-section. The design of the second part may even be specific to a particular vehicle model assembled by the customer, or a model for a particular market. Aspects of the second part 5 of the bracket which may vary from glazing to glazing (according to customer, etc., as described above) are e.g. its size, shape, thickness or the position of hole 7 for attaching the bracket to the winding mechanism.

The second part 5 of the bracket 2 engages with the first part 4 and is thus maintained in position relative to the glazing. Frequently the second part 5 will simply be attached to the first part 4. In the present embodiment, the first and second parts may clip together, or screws or other conventional fixings may be used to engage the second part with the first part. Details of the engaging mechanism are not shown in FIGS. 2 and 3; engagement is shown diagrammatically by arrow A. The first part 4 extends over the edge 8 and peripheral region 9 of the glazing, and the second part 5 is attached to the first part so as to depend from it, and consequently the second part 5 does not extend over any part of the glazing. While FIG. 3 shows part of a pane 3 of laminated glass, it could equally well be toughened glass. When assembling the glazing, adhesive may be applied to either the pane or the U-shaped base part 4. The second part may be attached in either the glazing manufacturer's factory or the customer's factory.

While the base part 4 of the first embodiment is usable with a wide variety of second parts 5 to provide a door glazing bracket, the concept of a universal base part can be developed further to provide a base part suitable for use with other types of mechanical member being e.g. centring or fixing pins, retaining clips, locating lugs, spacers or attachment studs, in short, with any of the small items of hardware which are generally attached to automotive glass.

FIGS. 4 and 5 show a second embodiment of the invention, in which the first or base part has been reduced to a single shape, namely a thin disc or flat cylinder. FIG. 4 shows a small part of a glazing pane 3 with a modified mechanical member 12 attached. The member again serves as a door glazing bracket, and comprises a first or base part 14 and a second part 15; in this case there are two first parts 14. The second part 15 has holes 19 (FIG. 5) of size and shape generally corresponding to the first parts 14 so that the second part 15 may receive the first parts 14. The second part is again provided with a hole 17 to permit attachment to a window winding mechanism. In this embodiment the second part 15 comprises an upper portion 19 of generally U-shaped cross-section for receiving the periphery of the pane, and a lower portion 20 which extends below the pane. As shown in FIG. 5, the pane 3 of glazing material has two major faces 10, 11 and at least one first part 14 is applied to each major face to maintain the second part in position.

During assembly, the second part 15 is positioned on the cleaned glazing first. Adhesive 16 is either injected onto the glazing through the holes 18, or, preferably (and as illustrated) applied to the first parts 14 which are then inserted into the holes 18. More preferably, the adhesive is pre-applied co the first parts, i.e. it is applied to them at an earlier time or date, possibly in a different location. Solid adhesive may be pre-shaped to suit the first part before application. Most conveniently, the first parts are bought from a supplier with a tack-free adhesive pre-applied; a suitable supplier is A. Raybond SARL of 68300 Saint-Louis, France.

The term “tack-free” refers to a solid adhesive which is not sticky to the couch, thereby facilitating handling. Such adhesives only become sticky after activation, and this term refers to any process which makes a tack-free adhesive sticky, initiating the bonding process. Activation also refers to the initiation of curing in a previously inert adhesive; it may involve melting the adhesive (at least on its surface), initiating a heat-dependent chemical reaction, or removing or destroying a barrier which separates two reactants. Activation may be carried out just before, or after, the insertion of the first parts in the holes.

A preferred adhesive for the present application is a polyurethane-based composition such as Techbond PUR from A. Raybond SARL. In this type of composition, the polyol and isocyanate reactants are pre-mixed in stoichiometric ratio, but the isocyanate is “end capped” or micro-encapsulated to prevent contact with the polyol. Application of heat activates the adhesive by destroying, e.g. melting, the capping or encapsulating membrane and allowing the isocyanate component into contact with the surrounding polyol so that the curing reaction starts. This adhesive does not require a primer.

With this type of adhesive, initial bond strength sufficient to hold the bracket in position is rapidly developed as the adhesive cools, possibly in less than 1 minute. Depending on the composition, full strength is developed within 30 minutes, 1 hour, or 3 to 5 hours, but this can occur while the glazings are in transit to the customer's premises.

FIG. 6 shows a third embodiment of bracket which is closely related to the second embodiment. Such is the strength of certain adhesives that half (i.e. one limb) of the U-shaped upper portion 19 of the second embodiment may be dispensed with. Accordingly, FIG. 6 shows a bracket 22 comprising a first part 14 (it being the same as in the second embodiment), and a single-limbed second part 25, which extends over only one major face 10 of the pane 3. Other aspects of the third embodiment are the same as for the second embodiment.

While the universally applicable base parts in the form of adhesive discs of the second embodiment are easy and convenient to use, that design of mechanical member or bracket does not allow the attachment of the second part to be delayed until, e.g. after delivery of the glazing, which was possible with the first embodiment. However, further modification of the third or “single limb” embodiment does render this possible.

Accordingly, FIGS. 7 and 8 illustrate a fourth embodiment of the invention which again utilises first or base parts in the form of adhesive discs, albeit slightly modified, and allows the fitting of the second part to be delayed. In this embodiment, a third or fixing part 41 (FIG. 8) attaches to the first or base part 34 to hold the second part 35 in place. The third part 41 may clip to the first part 34, or the parts may be threaded so that the third part is screwed into the first part. Thus the second part is maintained in position by the mutual engagement of the first and third parts. As before, the second part 35 has an upper portion 39 and a lower portion 40, which is provided with a hole 37 for attachment of the bracket to the window winding mechanism.

To assemble the fourth embodiment of mechanical member 32, the first or base parts 34 are provided, preferably with tack-free, shaped, solid adhesive pre-applied as described above, and bonded to the pane 33. One, two or more base parts may be used according to the size of the mechanical member and the load it may experience in use. Pane 33 has been shown as a monolithic pane of toughened class, but it could equally well be laminated glass.

Bonding the base parts 34 to the pane 33 generally involves loading a supply of the base parts into the magazine of an applicator machine or robot which heats, positions, and applies the base parts to the pane. A temperature in the range 100°-140° C. is suitable. The pane is supported on a suitable fixture, having been cleaned with isopropyl alcohol, Betaseal VP-04604 or other suitable cleaning agent. Further heating may be applied to the base parts to accelerate curing. Suitable rapid heating techniques include infra-red lamp, hot air jets, inductive heating or radio-frequency dielectric heating. With Techbond PUR, 30-50% of bonding strength may be attained in 5-40 seconds from first heating. Consequently, it is also possible to rapidly cool the base parts to 60°-80° C. with a fan to allow immediate handling or packing of the glazings. Full strength is achieved when post-polymerisation is complete, which may take from 20 seconds to 5 seconds.

The second part 35 may be attached in the glazing manufacturer's factory or at the customer's premises. It is fitted onto and engaged with the first parts 34, and the third or fixing parts 41 are screwed into the first parts 34 so as to maintain the second part in position. In effect the third or fixing parts 41 are short bolts with large, flat heads. All these parts may be moulded in standard engineering plastics, or machined in metal for greater strength. In this and earlier embodiments, the first or base parts in the form of thin discs or flat cylinders with similarly-shaped adhesive pre-applied may be thought of as adhesive versions of press-studs. Tbey are quick and simple to apply, and permit rapid, clean, economical and effective bonding of a wide variety of minor hardware components co glass and other sheet glazing materials.

The invention allows a faster production cycle, with reduced changeover times when changing the production tine over to a differing glazing. It makes packing the glazings simpler and more efficient, and reduces the possibility of damage. The use of solid tack-free adhesive avoids the need for handling or storage of dangerous chemicals such as adhesive reactants or primers. Poor adhesion due to bad priming operations or adverse influence of the environment (temperature, humidity) is alleviated.

While the invention has been illustrated and described in relation to a door glazing bracket, it is evident that it is also applicable to other mechanical components. The second part could for example be a pin or stud which screws into the first part in the way that the third part 41 does in the fourth embodiment. Alternatively, the second part could be a clip or spacer or carry lugs, e.g. to ensure correct positioning of a glazing in an aperture in a vehicle body, and be clipped or screwed to the first part.

Further adhesives which may be preferred in these other applications include moisture-cured polyurethane (e.g. Betaseal HV3 available from Gurit-Essex AG of Freienbach, Germany), moisture/heat cured polyurethane (e.g. Sika 360 HC available from Sika AG of Switzerland), reactive hot melt polyurethane (e.g.. PUR-FECT 310 available from National Starch & Chemical Company of Bridgewater, N.J., USA, a member of the ICI Group), and further two component polyurethanes. A further suitable class of adhesives is that of epoxy based compositions, e.g. Raybond's Techbond EPO. Also suitable are structural adhesive tapes (e.g. 3M 9214 available from the Minnesota Mining and Manufacturing Company of St. Paul, Minn., USA)

1. A glazing with a mechanical member attached thereto, characterised in that:
the mechanical member comprises a first or base part bonded to the glazing by adhesive,
and a second part maintained in position by engagement with the first part, wherein the first part is a standardised design usable with several differing designs of second part, each adapted to a differing glazing.

2. A glazing as claimed in claim 1, wherein the first part is generally in the form of a thin disc, and the second part has a hole of generally corresponding size and shape so that one part may receive the other part.

3. A glazing as claimed in claim 1, wherein the first part extends over the edge of the glazing, and the second part is attached to the first part in such a way that the second part does not extend over any part of the glazing.

4. A glazing as claimed in any preceding claim, wherein a third part attaches to the first part so as to hold the second part in place.

5. A glazing as claimed in claim 4, wherein the third part clips onto the first part.

6. A glazing as claimed in claim 4, wherein the first and third parts are provided with matching screw threads, so that the third part is screwed into the first part.

7. A glazing, as claimed in any preceding claim, comprising a pane of glazing material having two major faces, and at least one first part is applied to each major face.

8. A glazing as claimed in any preceding claim, wherein the adhesive is activated by heat.

9. A glazing as claimed in any preceding claim, wherein the mechanical member is a bracket, pin, clip, spacer or lug.

10. A method of making a glazing with a mechanical member attached thereto, characterised by the steps of:
(a) providing a pane of glazing material, and a mechanical member comprising a first or base part of a standardised design and a second part which is one of several differing designs of second part adapted to differing glazings, the first part being usable with the differing designs of second part,
(b) applying adhesive, to the pane or the first part of the mechanical member,
(c) positioning the first part on the pane, and maintaining it in position until the adhesive has partially cured, and
(d) engaging the second part of the mechanical member with the first part so as to maintain the second part in position,
wherein step (d) may be performed either before or after step (c).

11. A method as claimed in claim 10, wherein the first part is in the form of a thin disc, and the second part has a hole of generally corresponding size and shape so that one part may receive the other part.

12. A method as claimed in claim 10 or claim 11, wherein the adhesive cures fully within 1 hour, preferably within 30 minutes.

13. A method as claimed in any one of claims 10 or 12, including applying a solid adhesive in the form of a tack-free tablet.

14. A method as claimed in any one of claims 10 to 13, including pre-shaping a solid adhesive before applying it.

15. A method as claimed in any one of claims 10 to 14, including pre-applying the adhesive to the first part.

16. A method as claimed in any one of claims 10 to 15, including heating the adhesive to activate it before positioning the first part on the pane.

17. A method as claimed in any one of claims 10 to 16, including heating the adhesive to cure it, after positioning the first part on the pane.

18. A method as claimed in any one of claims 10 to 17, including transporting the glazing to a customer's premises, wherein the second part of the mechanical member is attached to the first part at the customer's premises.
